(19) United States
(12) Patent Application Publication
(10) Pub. No.: US 2014/0150198 A1
(43) Pub. Date: Jun. 5, 2014

(54) WIPER BLADE

(71) Applicant: KCW CORPORATION, Daegu (KR)

(72) Inventors: Kwan Hee Kim, Daegu (KR); Jae Hyuch An, Daegu (KR); Woo Sung Lee, Daegu (KR); Jin Wan Park, Daegu (KR)

(73) Assignee: KCW Corporation, Daegu (KR)

(21) Appl. No.: 13/748,311

(22) Filed: Jan. 23, 2013

(30) Foreign Application Priority Data
Dec. 3, 2012 (KR) 10-2012-0138826

(51) Int. Cl. B60S 1/40

(52) U.S. Cl. CPC B60S 1/4019
USPC 15/250.32

(57) ABSTRACT

In one aspect, the invention can be a wiper blade including a wiper strip which wipes a wiping surface; at least one pair of yoke levers which supports the wiper strip; a pair of auxiliary lever which is relatively rotatably coupled to the at least one pair of the yoke levers respectively; and a main lever which is relatively rotatably coupled to a pair of the auxiliary levers and is connected to a wiper arm, wherein, for the purpose of preventing interference caused at the time of pivoting with a U-hook type wiper arm “Ha,” the main lever includes a first concave portion which is formed toward the wiper strip in a portion of the top surface of the main lever.

### CROSS-REFERENCE TO RELATED APPLICATIONS

This application claims the benefit of Korean Patent Application No. 10-2012-0138826, filed Dec. 3, 2012, the entirety of which is hereby incorporated by reference.

### FIELD OF THE INVENTION

The present invention relates to a wiper blade, and more particularly to a wiper blade for a vehicle.

### BACKGROUND OF THE INVENTION

In general, a wiper blade removes impurities, snow, rain or the like when driving and prevents a driver's front sight from being deteriorated. A conventional wiper blade performs a repetitive reciprocating action in a fan shape as a motor drives a link apparatus connected to a wiper arm.

Since the shapes or sizes of conventional wiper arms for a vehicle are different from each other in accordance with manufacturers of wiper blades which are connected to the wiper arm, there is a limitation that only a dedicated wiper device can be used. Accordingly, product standardization for the wiper device is difficult to achieve, and thus the flexibility of product design is reduced. Moreover, since wiper blades which correspond to a variety of the wiper arms respectively should be manufactured, the time and cost required for manufacturing the wiper blades are increased.

Therefore, it is necessary to manufacture a wiper blade capable of being coupled to one or more wiper arms. However, the position and shape of a portion of a wiper arm, which is coupled to the wiper blade, are different from those of other wiper arms. As a result, there occurs interference when the wiper arm is pivoted with the wiper blade.

Here, with regard to the conventional wiper blade, through use of a pin or a rivet, a yoke member and an auxiliary lever are rotatably coupled to each other, and the auxiliary levers are rotatably coupled to each other. A spacer and the like which have a small friction coefficient is coupled to the coupling portion in order to reduce frictional resistance. Therefore, the number of parts constituting one wiper blade is as many as 20 and at least 15. Since the conventional wiper blade uses a metallic main lever and a metallic sub lever, the wiper blade is heavy.

The wiper blade which has a lot of parts and large weight gives a load to the wiper arm as well as a glass surface of the vehicle when the wiper blade is installed in the vehicle. As a result, breakdown may occur and the life span of the product may be shortened. Accordingly, a light wiper blade having an excellent assemblability is required to be developed.

### SUMMARY OF THE INVENTION

In one embodiment, the invention is directed to a wiper blade. The wiper blade includes: a wiper strip which wipes a wiping surface; at least one pair of yoke levers which supports the wiper strip; a pair of auxiliary lever which is relatively rotatably coupled to the at least one pair of the yoke levers respectively; and a main lever which is relatively rotatably coupled to a pair of the auxiliary levers and is connected to a wiper arm. For the purpose of preventing interference caused at the time of pivoting with a U-hook type wiper arm “Ha”, the main lever includes a first concave portion which is formed toward the wiper strip in a portion of the top surface of the main lever.

The U-hook type wiper arm “Ha” includes an arm bar connected directly to the wiper blade. A bent portion is formed in the arm bar. The first concave portion receives the bent portion. After the bent portion extends from the center of the wiper blade in a longitudinal direction of the wiper blade by a predetermined length “X,” the bent portion extends with an oblique bend at a predetermined angle in a direction in which traveling wind blows, and then is bent again parallel with the wiper blade in an “S” shape.

The first concave portion is formed separately from the center of the wiper blade by a predetermined length in a longitudinal direction of the wiper blade. The first concave portion is formed obliquely toward the lower portion from the upper portion of the main lever and toward the end from the center of the wiper blade.

The wiper blade further includes an adaptor which is assembled on the main lever and is directly connected to the wiper arm. A side of the main lever further includes one or more pin-holes and allowing the main lever to be coupled to a side pin-hole type wiper arm “Pa.” For the purpose of preventing interference caused at the time of pivoting with the side pin-hole type wiper arm “Pa,” the main lever further includes a second concave portion formed concave toward the lower portion of the wiper blade. The adaptor includes one or more coupling recesses which contact with the one or more pin-holes respectively and receive a side-pin of the side pin-hole type wiper arm “Pa,” and includes a U-Hook coupler having a curved portion receiving a U-Hook type wiper arm “Ha.”

The main lever is made of a resin material. The at least one pair of the yoke levers and a pair of the auxiliary levers are made of a resin material. The wiper blade further includes a spacer which is inserted between the auxiliary lever and the main lever and is made of a resin material. The inside of the main lever includes a slot intended to be coupled to the spacer and includes a catching recess preventing the spacer from being separated from the main lever. The spacer includes a rib intended to be coupled to the slot in a sliding manner and includes a catching projection which is caught by the catching recess. The catching projection is formed to have a degree of projection thereof increases toward the end of the wiper blade from the center of the wiper blade.

The main lever further includes a catching projection which projects downward from an inner ceiling of the main lever. The spacer further includes a catching recess which is formed in the upper portion of the spacer and by which the catching projection is caught. The main lever includes a protruding fitting portion which protrudes downward from an inner ceiling of the main lever. The auxiliary lever includes a receiving hole which is formed in the upper portion thereof and receives the protruding fitting portion.

The auxiliary lever includes a protruding fitting portion which protrudes downward from an inner ceiling of the auxiliary lever. The yoke lever includes a receiving hole which is formed in the upper portion thereof and receives the protruding fitting portion. The auxiliary lever includes a side projection which projects from both sides of one end of the central portion of the wiper blade. The auxiliary lever includes an inner projection which projects toward the inside of the spoiler from a lower inner side of the spoiler.

### BRIEF DESCRIPTION OF THE DRAWINGS

Arrangements and embodiments may be described in detail with reference to the following drawings in which like reference numerals refer to like elements and wherein:

FIG. 1 is a front perspective plan view of a wiper blade according to the present invention;

FIG. 2 is a perspective plan view of the wiper blade according to the present invention;

FIG. 3a is a perspective view showing one end of a wiper strip according to the present invention;

FIG. 3b is a perspective view showing the other end of the wiper strip according to the present invention:

FIG. 4 is an exploded front view of the wiper blade according to the present invention;

FIG. 5 is an exploded perspective view of the wiper strip according to the present invention;

FIGS. 6a and 6b are perspective views showing an auxiliary lever, a yoke lever and a spacer of the wiper blade according to the present invention;

FIGS. 7a to 7c show the wiper blade supporting six points of the wiper strip;

FIG. 8 is a cross sectional view taken along line VA of FIG. 1;

FIG. 9a is a perspective view showing how a main lever is coupled to the auxiliary lever in accordance with the present invention;

FIG. 9b is a perspective view showing the main lever and the spacer according to the present invention;

FIGS. 9c and 9d are bottom views showing the main lever and the spacer according to the present invention;

FIG. 10 is an exploded perspective view showing the main lever of the wiper blade to which wiper arms having various shapes are coupled;

FIG. 11a is a plan view showing a U-hook type wiper arm coupled to the wiper blade;

FIG. 11b is a perspective view showing that the wiper blade and an arm bar of the U-hook type wiper arm have been coupled to each other;

FIG. 12 shows a plan view and a front view of the wiper blade to which the arm bar of the U-hook type wiper arm has been coupled;

FIG. 13 shows a plan view and a front view of a first concave portion;

FIG. 14 is a perspective view showing that the wiper blade and a side pin-hole type wiper arm have been coupled to each other; and

FIGS. 15a and 15b are bottom views showing the main lever and the auxiliary lever.

### DETAILED DESCRIPTION OF THE INVENTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

Hereafter, exemplary embodiments of the present invention will be described in detail with reference to the accompanying drawings in order that the present invention may be easily implemented by those skilled in the art.

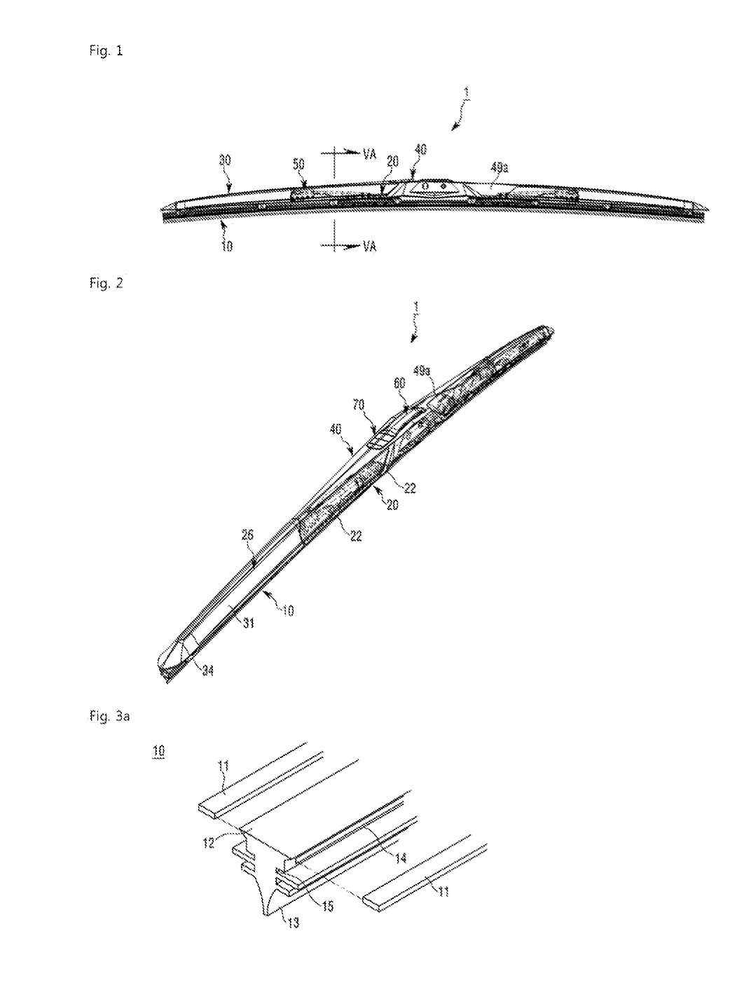

FIGS. 1 and 2 are a front perspective plan view and a perspective plan view which show an overall configuration of a wiper blade according to the present invention. Referring to FIGS. 1 and 2, a wiper blade 1 according to the present invention includes a wiper strip 10, at least one pair of yoke levers 20 which supports the wiper strip 10, a pair of auxiliary levers 30 which is relatively rotatably coupled to the at least one pair of the yoke levers 20 respectively, and a main lever 40 which is relatively rotatably coupled to a pair of the auxiliary levers 30 and is connected to a wiper arm.

For the purpose of preventing interference caused at the time of pivoting with a U-hook type wiper arm (not shown), the main lever 40 includes a first concave portion 49a which is formed toward the wiper strip 10 in a portion of the top surface of the main lever 40.

The wiper blade 1 according to an embodiment of the present invention is connected to the front end of the wiper arm (not shown) and is pressurized by the wiper arm in a direction of a glass surface of a vehicle. The wiper arm rotates reciprocatively at a predetermined angle by a wiper motor (not shown). Accordingly, the wiper blade 1 wipes the glass surface (wiping surface) of the vehicle within the predetermined angle.

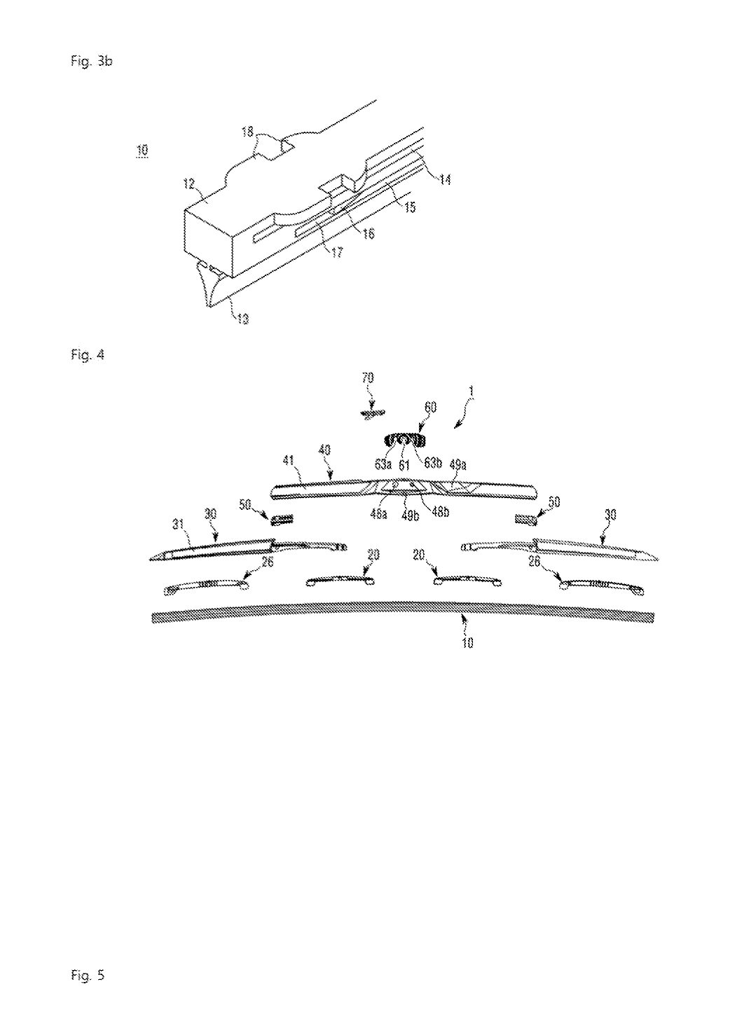

FIGS. 3a and 3b are partial perspective views showing one end and the other end of the wiper strip respectively. Referring to FIGS. 1, 2, 3a and 3b, the wiper blade 1 further includes two baking plates 11 which are mounted on the wiper strip 10. As shown in FIGS. 1, 2, 3a and 3b, the wiper strip 10 includes a wiping lip 13 and a base 12. The wiping lip 13 contacts directly with and wipes the glass surface. The base 12 is supported by the yoke lever 20 or the auxiliary lever 30. The wiper strip 10 is disposed to contact directly with the glass of the vehicle in a sliding manner and removes impurities of the glass surface. The wiper strip 10 extends in a longitudinal direction thereof and is made of an elastic material like a rubber material or made of an elastic composite material.

The base 12 is supported by a fastener of the yoke lever 20 or the auxiliary lever 30. The fastener may have a yoke shape. The base 12 and the wiping lip 13 continuously extend in a longitudinal direction of the wiper strip 10. A receiving recess 14 in which the two parallel baking plates 11 may be received extends in the base 12 in a longitudinal direction thereof. The two rectangular metallic baking plates 11 having spring characteristics are received in the two baking plate receiving recesses 14 respectively. A holding portion 15 receives the fastener in a sliding manner.

As shown in FIG. 3a, the holding portion 15 at the one end of the wiper strip 10 is open so as to receive the fastener. However, as shown in FIG. 3b, the other end of the wiper strip is formed to limit the longitudinal direction movement of the fastener of one of a pair of the auxiliary levers 30. That is, the fastener supporting the other end is limited by a coupler 17 and a wall of a slope 16 provided only at the other end of the holding portion 15. Also, the longitudinal direction movement of the fastener is limited by a protrusion 18.

The baking plate 11 applies elasticity and rigidity to the wiping lip 13. When a pressurizing force is applied from the wiper arm, the pressurizing force is distributed to the wiper strip 10 through the levers. Here, the pressurizing force is distributed by the baking plate 11 in the longitudinal direction of the wiper strip 10, Accordingly, the baking plate 11 should have elasticity and rigidity to maintain the shape of the wiper strip 10. A plurality of the baking plates 11 and a plurality of the baking plate receiving recesses 14 may be provided according to the rigidity or elasticity of the wiper strip.

Next, an embodiment of the wiper blade according to the present invention will be described. FIGS. 4 and 5 are respectively an exploded front view and an exploded perspective view of the wiper blade according to the embodiment of the present invention. Referring to FIGS. 1, 2, 4 and 5, the wiper blade according to the embodiment of the present invention may include an adaptor 60 which is assembled on the main lever 40 and is directly connected to the wiper arm. A side of the main lever 40 may further include one or more pin-holes 48a and 48b allowing the main lever 40 to be coupled to a side pin-hole type wiper arm (not shown). The adaptor 60 may include one or more coupling recesses 63a and 63b which contact with the one or more pin-holes 48a and 48b respectively and receive a side-pin of the side pin-hole type wiper arm, and may include a U-Hook coupler 62 having a curved portion receiving a U-Hook type wiper arm.

The main lever 40 applies the pressurizing force applied from the wiper arm (not shown) to the auxiliary lever 30. The auxiliary lever 30 applies at least some of the pressurizing force to the at least one pair of the yoke levers 20. The at least one pair of the yoke levers 20 includes a first yoke lever 25 and a second yoke lever 26. The first yoke lever 25 and the second yoke lever 26 pressurize the wiper strip 10, thereby causing the wiper strip 10 to stably wipe the glass surface of the vehicle. A spacer 50 is inserted between the auxiliary lever 30 and the main lever 40, so that the rigidity of the wiper blade 1 is increased and a gap between the two levers can be prevented from being generated.

As shown in FIGS. 4 and 5, the first yoke lever 25 and the second yoke lever 26 pressurize the wiper strip 10 and support the wiper strip in such a manner as to be slidable. The first yoke lever 25 is disposed separately from an end of the wiper strip 100 toward the center of the wiper strip 10. The first yoke lever 25 includes a catching recess 21, a pair of fasteners 22 and a receiving hole 23. The second yoke lever 26 includes a catching recess 29 and a pair of fasteners 27 and 28. A pair of the first yoke levers 25 and a pair of the second yoke levers 26 may be made of a resin material in an injection molding method.

The catching recess 21 of the first yoke lever 25 is formed in the side of the first yoke lever 25. The catching recess 21 may be formed concave in a direction of the width of the first yoke lever 25. A catching protrusion 35 to be described below of the auxiliary lever 30 is coupled to the catching recess 21. The auxiliary lever 30 performs a relative rotation with the first yoke lever 25 with an axis of the catching recess 21. A pair of the fasteners 22 may be formed in both ends of the first yoke lever 25. The fastener 22 supports the wiper strip 10 in such a manner as to be slidable.

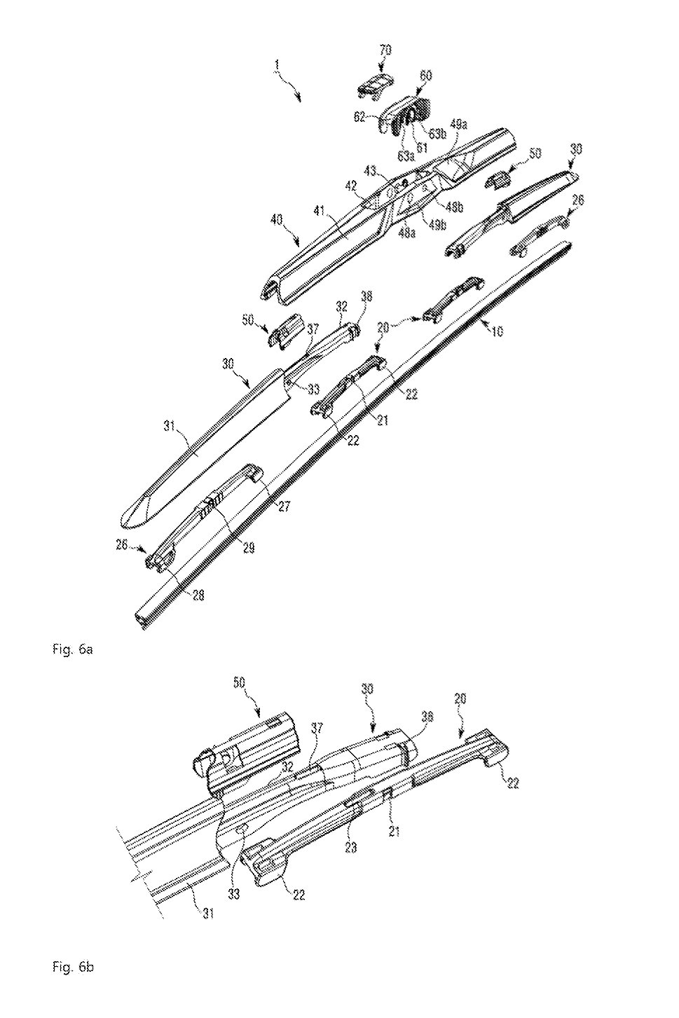

FIGS. 6a and 6b are exploded perspective views showing the yoke lever, the auxiliary lever and the spacer. Referring to FIGS. 4 to 6b, the receiving hole 23 is formed in the upper surface of the first yoke lever 25. As shown in FIGS. 4 to 6b, a protruding fitting portion 36 to be described below of the auxiliary lever 30 is inserted and fixed to the receiving hole 23. When the protruding fitting portion 36 of the auxiliary lever 30 is inserted and fixed to the receiving hole 23, a gap between the auxiliary lever 30 and the yoke lever 20 is reduced and torsional flow is prevented when a wiping is performed. The resin material-made wiper blade is light and is easy to manufacture but has lower rigidity than that of a metallic wiper blade. Accordingly, in the wiper blade 10 according to the embodiment of the present invention, the protruding fitting portion 36 of the auxiliary lever 30 is inserted and fixed into the receiving hole 23 of the first yoke lever 25. As a result, when the wiping is performed, a resistance to a bending moment and a torsional moment which are applied to a coupling portion of the two levers is increased. There is also an effect that a gap between the two levers is reduced. In the embodiment of the present invention, a cross section as viewed from the top of the receiving hole 23 has a quadrangular shape. However, the shape of the cross section of the receiving hole 23 is not limited to this.

The receiving hole 23 may be formed separately from the center of the first yoke lever 25 toward the end of the wiper blade in order to increase the rigidity for the moment applied to the first yoke lever 25. As will described below, the auxiliary lever 30 may be inserted into the lower portion of the main lever 40 and may further include a side projection 38 for reducing a gap between the auxiliary lever 30 and a lower inner side of the main lever when the auxiliary lever 30 is pivoted. At least one side projection 38 may be formed.

As shown in FIG. 6b, the lower inside of a spoiler 31 of the auxiliary lever 30 is formed to have an open type for receiving the second yoke lever 26. A protrusion to be coupled to the second yoke lever 26 may be formed at the inside of the spoiler 31 of the auxiliary lever 30. The protrusion is caught by and coupled to the catching recess 29 formed in the side of the second yoke lever 26. A pair of the first yoke levers 25 and a pair of the second yoke levers 26 support four points of the wiper strip (not shown) respectively, and totally support eight points of the wiper strip. The first and the second yoke levers 25 and 26 pressurize the eight points of the wiper strip, thereby allowing the wiper strip to stably wipe the glass surface of the vehicle.

Meanwhile, in the auxiliary lever 30, an inner projection 39 may be formed inside the lower portion of the spoiler 31. The inner projection 39 may be formed to project toward the inside of the spoiler 31 from the lower inner side of the spoiler 31. When the wiper blade 10 is pivoted, the inner projection 39 reduces a side gap between the auxiliary lever 30 and the second yoke lever 26. A catching protrusion 39a may be formed in the central portion of the inner projection 39. The catching protrusion 39a may be coupled to the catching recess 29 of the second yoke lever 26. Further, the auxiliary lever 30 may include the side projection 38 which reduces the gap between the auxiliary lever 30 and the lower inside of the main lever 40 and is formed at more than two positions of the auxiliary lever 30.

When the side projection 38 of the auxiliary lever 30 is inserted into the lower inside of the main lever 40, the side projection 38 reduces the gap between one end of the auxiliary lever 30 and both sides of the lower inside of the main lever 40. The side projection 38 is integrally formed with the auxiliary lever 30 and is made of an elastic resin material. The side projection 38 increases an effective area of one end of the central portion of the wiper blade of the auxiliary lever 30, increases a resistance to a moment applied to one end of the auxiliary lever 30 and reduces a side gap between the auxiliary lever 30 and the main lever 40. Therefore, the rigidity and wiping performance of the wiper blade are improved.

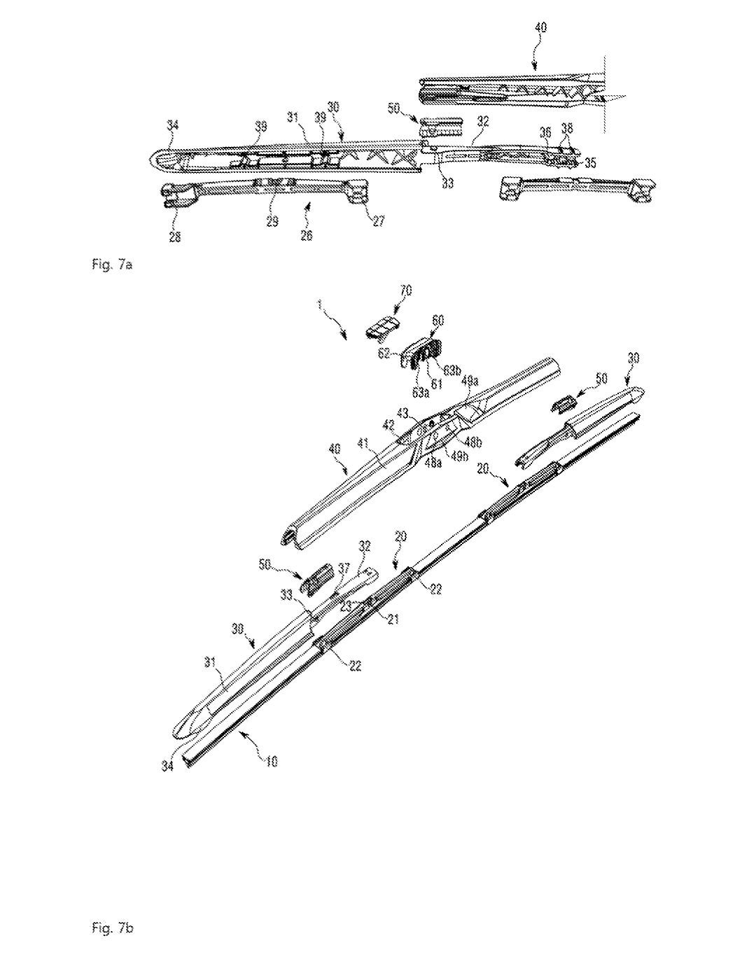

FIGS. 7a to 7c show an embodiment of the wiper blade supporting six points of the wiper strip. Referring to FIGS. 7a to 7c, in the wiper blade according to the embodiment of the present invention, the main lever 40 applies the pressurizing force applied from the wiper arm (not shown) to the auxiliary lever 30. The auxiliary lever 30 applies some of the pressurizing force to the yoke lever 20. The auxiliary lever 30 and the yoke lever 20 pressurize the wiper strip 10, thereby causing the wiper strip 10 to stably wipe the glass surface of the vehicle. The spacer 50 is inserted between the auxiliary lever 30 and the main lever 40, so that the rigidity of the wiper blade 1 is increased and a gap between the two levers can be prevented from being generated.

In other words, the fasteners 22 of a pair of the yoke levers 20 support four points of the wiper strip 10 and fasteners 34 of a pair of the auxiliary lever 30 support two points of both ends of the wiper strip 10. Accordingly, six points of the wiper strip 10 are supported by the fasteners. That is, in the wiper blade 1 according to the embodiment of the present invention, the number of the yoke levers 20 may be changed according to the size or curvature of the glass surface of the vehicle. The number of parts of the wiper blade having the six-point support structure becomes less than the number of parts of the wiper blade having the eight-point support structure. Accordingly, it is economical to use the wiper blade having the six-point support structure. Also, the wiper blade having the six-point support structure can be used in the vehicle's glass surface having a relatively small size or a small curvature.

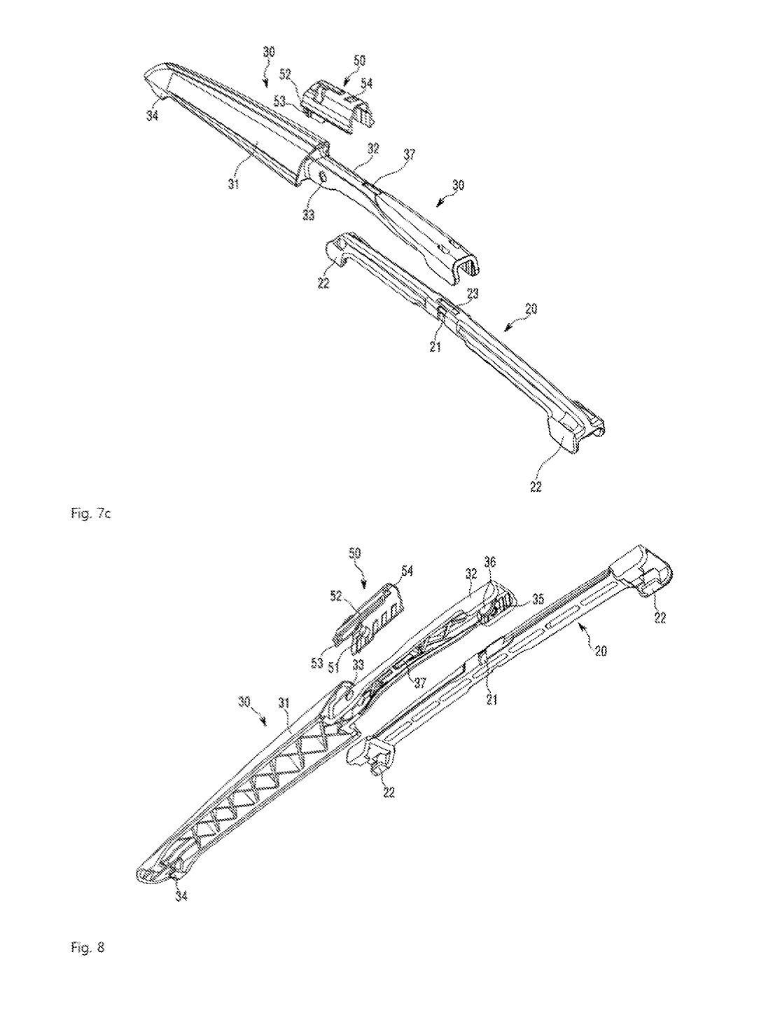

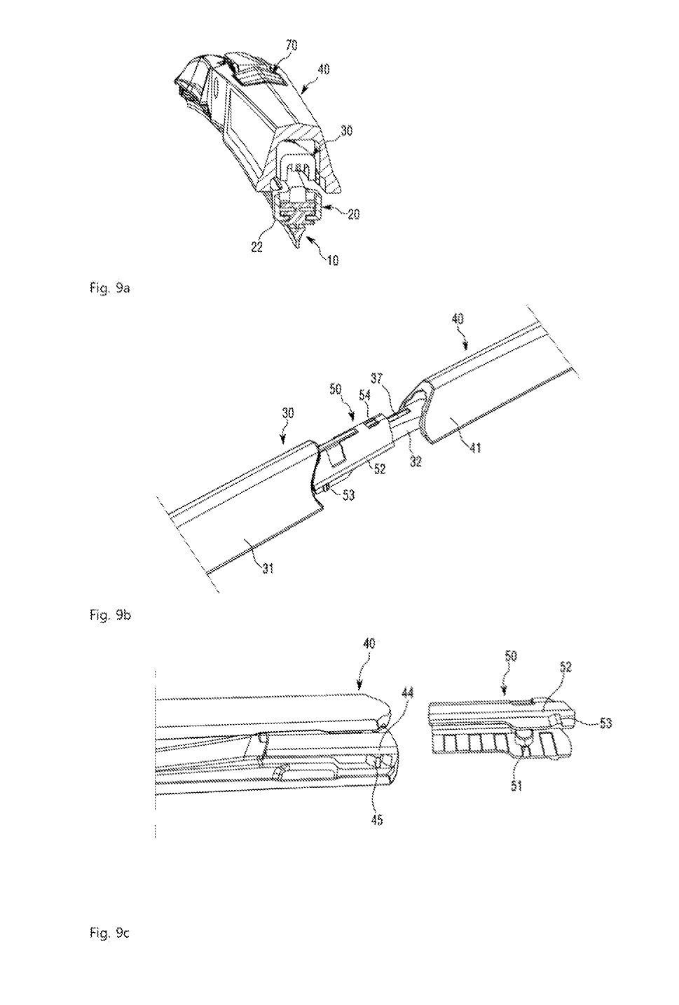

FIG. 8 is a sectional perspective view taken along line VA of the wiper blade shown in FIG. 1. Referring to FIGS. 4 to 8, the auxiliary lever 30 transfers the pressurizing force applied from the main lever 40 to the wiper strip 10 and the at least one yoke lever 20. The auxiliary lever 30 may include the spoiler 31, an extension part 32, an insertion hole 33, the fastener 34, the catching protrusion 35, the protruding fitting portion 36 and a receiving hole 37. The fastener 34 is formed in one end of the auxiliary lever 30 and supports one end of the wiper strip 10 in such a manner as to be slidable. The catching protrusion 35 is formed in the other end of the auxiliary lever 30 and is coupled to the yoke lever 20 in such a manner as to perform a relative rotation with the yoke lever 20. The auxiliary lever 30 may be made of a resin material in an injection molding method.

The spoiler 31 is integrally formed with the top surface of a portion of the auxiliary lever 30. The spoiler 31 may be implemented by processing the shape of the top surface of the auxiliary lever 30. When the wiping is performed, the spoiler 11 induces air such that the air flowing toward the glass surface of the vehicle pressurizes the auxiliary lever 30 in a direction closer to the glass surface of the vehicle.

The extension part 32 is coupled to the spacer 50 to be described below and is received within the lower portion of the main lever 40. The extension part 32 is coupled to the first yoke lever 25 in such a manner as to perform a relative rotation with the first yoke lever 25. The extension part 32 includes the insertion hole 33 functioning as a rotational axis at the time of performing a relative rotation with the main lever 40. A fitting protrusion 51 to be described below of the spacer 50 is coupled to the insertion hole 33. The catching protrusion 35 is formed in the other end of the extension part. 32. The catching protrusion 35 protrudes toward the catching recess 21 from the inner circumferential side wall of the auxiliary lever 30 in such a manner as to be elastically received in the catching recess 21 of the first yoke lever 25. Through the coupling of the catching protrusion 35 and the catching recess 21, the first yoke lever 25 and the auxiliary lever 30 are separable from each other and rotatably coupled to each other. The receiving hole 37 to which a protruding fitting portion 46 to be described below of the main lever 40 is inserted and fixed is formed in the upper portion of the extension part 32. The protruding fitting portion 46 is inserted and fixed to the receiving hole 37, so that a gap between the auxiliary lever 30 and the main lever 40 is reduced and torsional flow is prevented when the wiping is performed. Accordingly, the rigidity of the resin material-made lever is increased.

The spacer 50 is inserted between the auxiliary lever 30 and the main lever 40 to be described later. The spacer 50 strengthens the coupling of the auxiliary lever 30 and the main lever 40 and reduces the gap therebetween. The fitting protrusion 51 which is inserted and fixed to the insertion hole 33 of the auxiliary lever 30 is formed in the inner surface of the spacer 50. A rib 52 is formed on the outside of the spacer 50 in the longitudinal direction of the wiper blade 1. The spacer 50 and the main lever 40 may be coupled to each other by sliding the rib 52 in a slot 44 formed in the main lever 40. It is recommended that the rib 52 is formed closer to the insertion hole 33 for the purpose of increasing the rigidity of the wiper blade. Regarding a conventional metallic spacer, the rib should be placed in the lower portion of the spacer due to a manufacturing process of the conventional metallic spacer. However, since the spacer according to the embodiment of the present invention is made of a resin material, the rib can be formed closest to the insertion hole 33. A catching projection 53 received in a catching recess 45 of the main lever 40 is formed in the lower portion of the spacer 50. Also, a catching recess 54 to which a catching projection (not shown) formed in the main lever 40 is caught and connected is formed in the top surface of the spacer 50.

That is, due to the characteristic that the spacer according to the embodiment of the present invention is formed of a resin material, a shape flexibility of the spacer is increased and the spacer is able to perform all of the functions of the conventional spacer and spacer clip. Accordingly, the number of parts can be reduced. As a result, manufacturing costs and process time can be reduced.

FIG. 9a is a perspective view showing how the main lever, the spacer and the auxiliary lever are coupled to each other. FIG. 9b is a perspective view showing the main lever and the spacer. FIGS. 9c and 9d are bottom views showing the main lever and the spacer. Referring to FIGS. 4 to 9d, both ends of the main lever 40 are connected a pair of the auxiliary levers 30. The main lever 40 applies the pressurizing force applied from the wiper arm (not shown) to the auxiliary lever 30. The main lever 40 may include a spoiler 41, an arm coupling hole 42, a central axis 43, the slot 44, the catching recess 45, the protruding fitting portion 46 and a catching projection 47. The main lever 40 may be made of a resin material and may be manufactured by an injection molding method.

The spoiler 41 is integrally formed with the top surface of the main lever 40. The spoiler 41 can be obtained by processing the shape of the top surface of the main lever 40. When the wiping is performed, the spoiler 31 induces air such that the air flowing toward the glass surface of the vehicle pressurizes the main lever 40 in a direction closer to the glass surface of the vehicle.

The arm coupling hole 42 to which the wiper arm (not shown) is coupled is formed in the longitudinal central portion of the main lever 40. The central axis 43 traversing the arm coupling hole 42 in the width direction of the arm coupling hole 42 is formed in the arm coupling hole 42. An adaptor 60 which is directly connected to the wiper arm (not shown) is assembled on the central axis 43. Meanwhile, a cover member 70 may be coupled to the arm coupling hole 42.

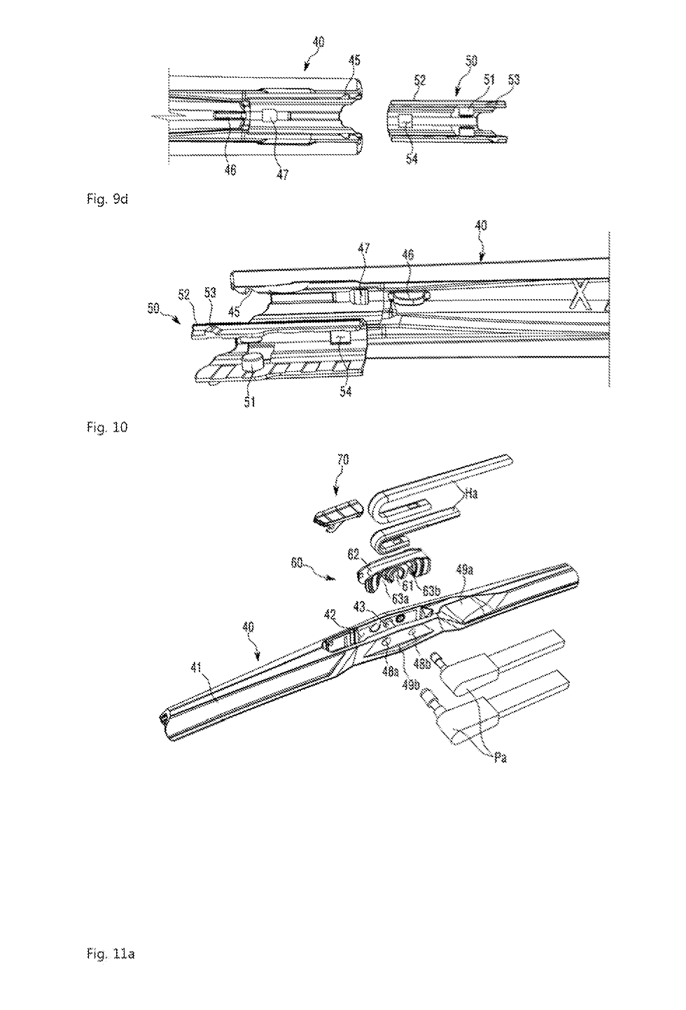

A variety of the wiper arms may be coupled to the wiper blade 1. Hereafter, the main lever 40 to which various wiper arms can be coupled will be described. FIG. 10 shows the main lever of the wiper blade to which wiper arms having various shapes are coupled. Referring to FIG. 10, a side of the main lever 40 may include a first pin-hole 48a and a second pin-hole 48b, to which a side pin-hole type wiper arm “Pa” of which the pin projects toward the side thereof. The first and the second pin-holes 48a and 48b may have different sized holes such that they can be selectively coupled according to the size of the wiper arm “Pa”.

The adaptor 60 assembled on the central axis 43 of the main lever 40 is formed to receive all of a U-Hook type wiper arm “Ha” and the side pin-hole type wiper arm “Pa”. Specifically, an axis coupling recess 61 which is approximately formed in the central portion of the adaptor 60 is coupled to the central axis 43 of the main lever 40. By doing this, the adaptor 60 is rotatably assembled with the main lever 40. The wiper arm is assembled on the adaptor 60. The adaptor 60 includes the U-Hook coupler 62 which has a curved portion receiving the U-Hook type wiper arm “Ha”. The wiper arm “Ha” may be selectively coupled to the U-Hook coupler 62 in accordance with the size of the wiper arm “Ha”. Since the U-Hook type wiper arm “Ha” and the side pin-hole type wiper arm “Pa” have been already well known, a detailed description of how they are coupled to the wiper blade will be omitted.

In the mean time, for the purpose of preventing interference caused when the main lever 40 is pivoted with the U-Hook type wiper arm “Ha”, the main lever 40 includes the first concave portion 49a which is formed toward the wiper strip 10 in a portion of the top surface of the main lever 40. At least one of both sides of the main lever 40 may further include a second concave portion 49b formed concave toward a lower portion of the main lever 40. When the wiper blade 1 and the side pin-hole type wiper arm “Pa” are coupled and pivoted, the second concave portion 49b prevents the side of the main lever 40 and the wiper arm “Pa” from causing interference and from interfering with the smooth pivot between the wiper blade 1 and the side pin-hole type wiper arm “Pa”.

FIG. 11a is a plan view showing a U-hook type wiper arm coupled to the wiper blade. FIG. 11b is a perspective view showing that the wiper blade and an arm bar of the U-hook type wiper arm have been coupled to each other.

As shown in FIGS. 11a and 11b, the U-Hook type wiper arm “Ha” is pivotably coupled to the adaptor 60. An arm bar 100 of the U-Hook type wiper arm “Ha” may contact closely with one side of the spoiler 41 of the main lever 40. Based on the kind of the U-Hook type wiper arm “Ha”, the arm bar 100 of the wiper arm may or may not contact closely with the spoiler 41. In the U-Hook type wiper arm “Ha”, the arm bar 100 of which the one side is formed to have a U-shape is coupled to the adaptor 60 of the wiper blade 1. The other side of the arm bar 100 has a coupling hole 101 formed therein. The other side of the arm bar 100 is fixed to a retainer 110 by the coupling hole 101. One side of the retainer 110 is coupled to the arm bar 100. The other side of the retainer 110 is coupled to an arm head 120. Since the coupling of the arm bar 100 to the retainer 110 and the coupling of the retainer 110 to the arm head 120 have been widely known, detailed descriptions thereof will be omitted.

In the embodiment of the present invention, in the main lever 40 of the wiper blade 1 of the present invention, a portion of the spoiler 41 which may cause the interference with the arm bar 100 is formed concave toward the wiper strip 10 in order to prevent the U-Hook type wiper arm “Ha”, which may cause the interference with the spoiler 41 of the main lever 40, from causing the interference with the spoiler 41. Therefore, the arm bar 100 may be easily pivoted without causing the interference with the spoiler 41 of the main lever 40.

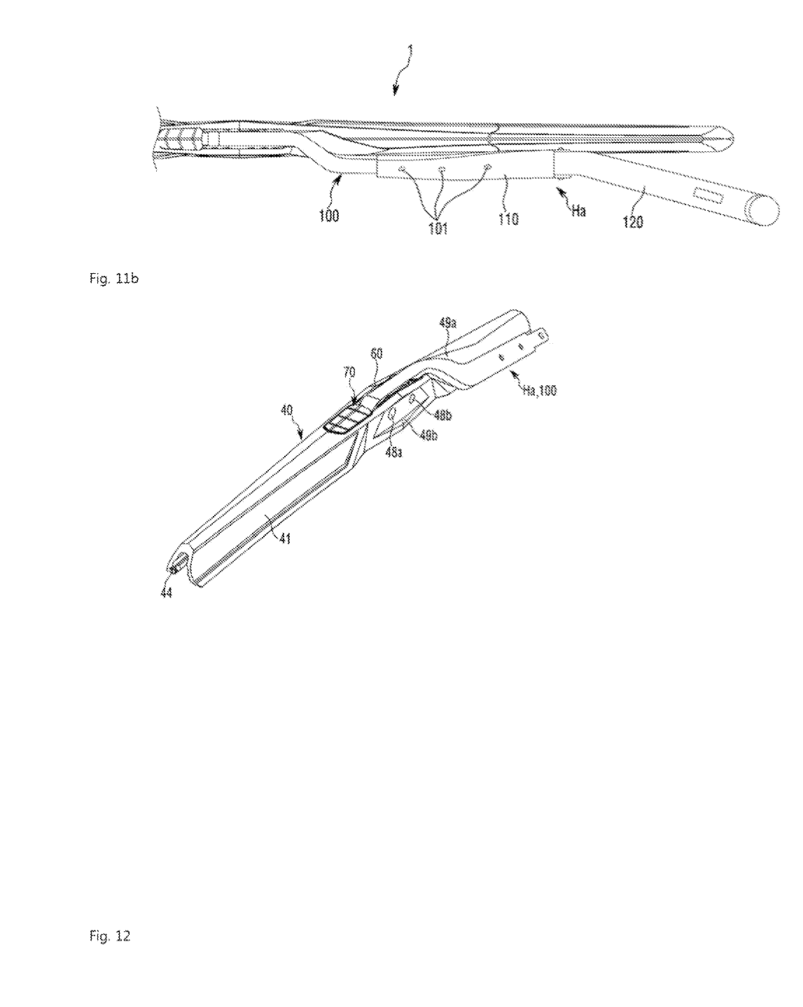

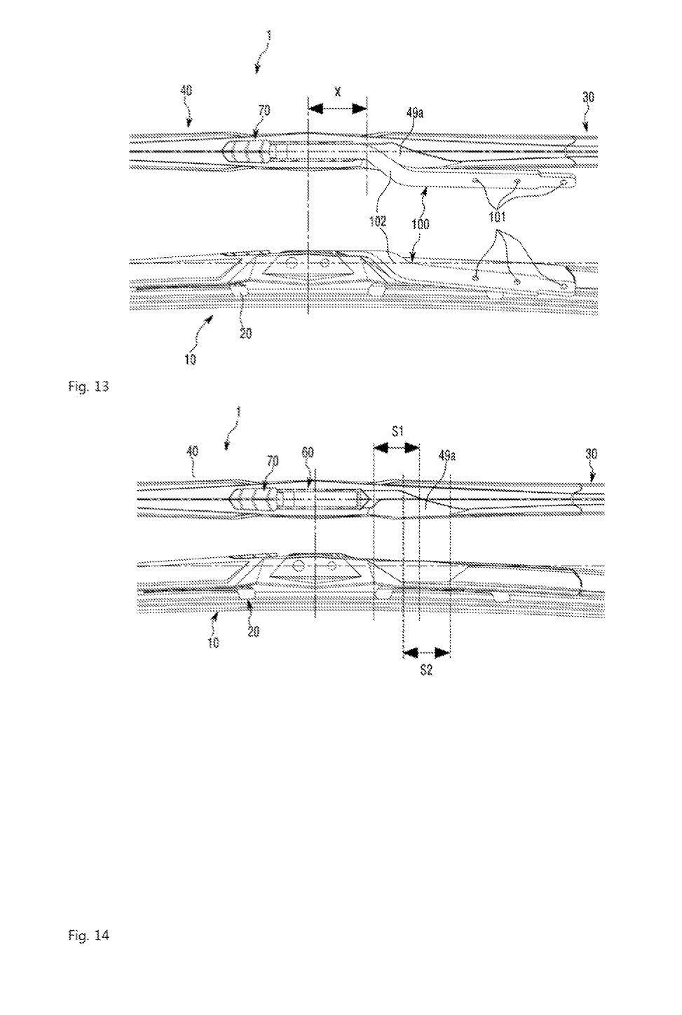

Hereafter, the first concave portion 49a will be described in detail. FIG. 12 shows a plan view and a front view of the wiper blade to which the arm bar of the U-hook type wiper arm has been coupled. FIG. 13 shows a plan view and a front view of a first concave portion. Referring to FIGS. 11a, 11b and 12, the arm bar 100 of the U-Hook type wiper arm “Ha”, which is coupled to the wiper blade 1 according to the embodiment of the present invention, is coupled to the adaptor 60 and extends in a longitudinal direction of the wiper blade 1 by a predetermined length “X”. After the extension, the arm bar 100 extends with an oblique bend at a predetermined angle toward the front of the vehicle, i.e, a direction in which traveling wind blows, and then is bent again almost parallel with the wiper blade 1. In other words, the arm bar 100 includes a bent portion 102 which is bent twice in “S”-shape. A bent angle of the bent portion 102 may be changed according to the length of the glass surface of the vehicle, the curvature of the glass surface, the length of wiper blade 1 and the like. When the other side of the arm bar 100 is coupled to the retainer 110, the retainer 110 functions as a screen blocking the traveling wind blowing to the wiper blade 1. That is, at least a portion of the traveling wind is blocked by the side of the retainer 110 and then blows in another direction without reaching the spoilers 31 and 41 of the wiper blade 1. Accordingly, lifting of the wiper blade 1 due to the traveling wind can be prevented and the aesthetic feature can be improved by screening the external appearance of the wiper blade 1.

As shown in FIG. 12, the first concave portion 49a is formed separately from the center of the wiper blade 1 at a predetermined distance. The arm bar 100 is made of a metallic material. A minimum distance is required in the process so as to form the bent portion 102 in the metallic material. Since the width of the arm bar 100 is formed within a range between 8.8 to 9 mm, the predetermined length “X” corresponding to the width of the arm bar 100 is approximately at least 30 mm.

Referring to FIG. 13, the first concave portion 49a in which the bent portion 102 may be received is formed in one side of the top surface of the main lever 40 so as to prevent the interference with the bent portion 102. The first concave portion 49a may be formed on the spoiler 41 of the main lever 40. The first concave portion 49a has a shape which is obliquely concave toward the lower portion from the upper portion of the main lever 40 and toward the end from the center of the wiper blade 1.

Therefore, the first concave portion 49a is able to prevent the interference between the arm bar 100 and the spoiler 41 by receiving the bent portion 102. Also, the main lever 40 receives the bent portion 102, so that the arm bar 100 and the spoiler 41 are able to contact with each other as closely as possible within a range that no interference between the arm bar 100 and the spoiler 41. Accordingly, when the wiping is performed, it is possible to stably transfer a rotation force transferred from the arm head 120 to the wiper blade 1, thereby preventing chattering of the wiper, and the like and improving wiping performance.

As shown in FIG. 13, while the embodiment shows that the length “S1” of the upper portion of the concave portion 49a and the length “S2” of the lower portion of the concave portion 49a are identically 35 mm, there is no limit to this. The lengths may be changed according to the shape of the arm bar 100. Specifically, the lengths may be changed according to the width, thickness, bending degree and the like of the arm bar 100, and the entire length of the concave portion 49a in a longitudinal direction of the wiper blade 1 may be approximately 60 mm. If the width of the first concave portion 49a is too small, the first concave portion 49a may cause the interference with the bent portion 102. It the width of the first concave portion 49a is too large, the spoiler 41 becomes smaller and the lifting of the wiper blade 1 may occur. Therefore, it is recommended that the first concave portion 49a is able to receive the arm bar 100 and is formed to have a minimum size which does not cause the interference between the main lever 40 and the arm bar 100.

Since the main lever 40 according to the embodiment of the present invention is made of a resin material, shape flexibility of the main lever 40 is increased. Therefore, the first concave portion 49a which is capable of receiving the arm bar 100 and the bent portion 102 in accordance with the shapes of the arm bar 100 and the bent portion 102 can be easily formed in the main lever 40.

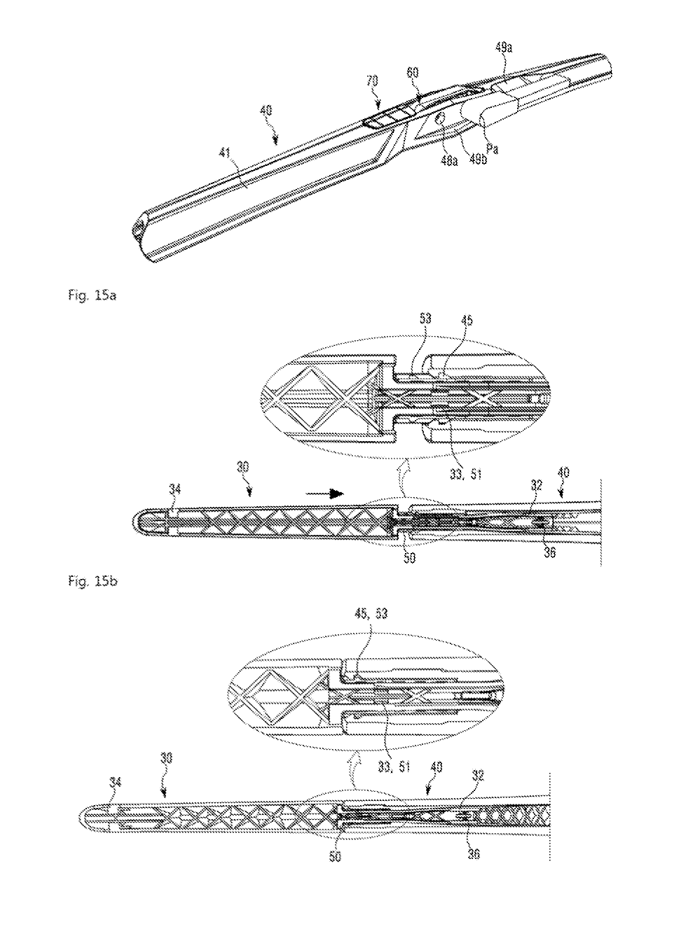

FIG. 14 shows that the wiper blade and a side pin-hole type wiper arm have been coupled to each other. As shown in FIG. 14, the side pin-hole type wiper arm “Pa” is pivotably coupled to the adaptor 60. The side pin-hole type wiper arm “Pa” contacts closely with one side of the main lever 40. In the main lever 40 of the wiper blade 1 of the present invention, the side coupled to the wiper arm “Pa” is formed concave toward the lower portion of the main lever 40. Accordingly, the wiper arm “Pa” can be easily pivoted without causing the interference with the side of the main lever 40. Accordingly, both of the U-Hook type wiper arm “Ha” and the side pin-hole type wiper arm “Pa” can be coupled to the main lever 40 of the wiper blade 1 according to the embodiment of the present invention. Also, the interference caused when the wiper arms are pivoted can be minimized.

Hereafter, a coupling relation between the main lever and the auxiliary lever will be described. Referring to FIGS. 9a and 9d, the bottom surface of the main lever 40 is open and is able to receive the extension part 32 of the auxiliary lever 30. Both ends of the main lever 40 are able to perform a relative rotation with the auxiliary lever 30 and are separably coupled to the auxiliary lever 30. Specifically, the slot 44 to which the rib 52 of the spacer 50 may be coupled in a sliding manner is formed inside the main lever 40. Also, the catching recess 45 by which the catching projection 53 of the spacer 50 may be caught is formed in the lower portion of the main lever 40. The catching recess 45 is formed to have a shape for receiving the catching projection 53. The catching recess 45 is symmetrically formed in both inner sides of the main lever 40. The main lever 40 is pivoted integrally with the spacer 50 about the insertion hole 33 of the auxiliary lever 30.

As shown in FIGS. 9a to 9d, the protruding fitting portion 46 which protrudes downward from the ceiling of the main lever 40 and is inserted and fixed to the receiving hole 37 of the auxiliary lever 30 is formed on the inner top surface of the both ends of the main lever 40. The protruding fitting portion 46 is inserted and fixed to the receiving hole 37, so that a gap between the auxiliary lever 30 and the main lever 40 is reduced and a resistance to a bending moment and a torsional moment is increased when the wiping is performed.

Further, the catching projection 47 which projects downward from the ceiling and is caught by the catching recess 54 of the sparer 50 is formed on the inner top surface of the both ends of the main lever 40. The catching projection 47 is caught by the catching recess 54, so that the spacer 50 and the main lever 40 can be more strongly coupled to each other.

As shown in FIGS. 9a to 9d, the auxiliary lever 30 to which the spacer 50 is coupled is coupled to the main lever 40 in a sliding manner. Here, the rib 52 of the spacer 50 is guided and slid on the slot 44 formed inside the main lever 40. The catching recess 45 is formed on the lower portion of the end of the main lever 40, and then the catching projection 53 formed in the lower portion of the spacer 50 is caught by the catching recess 45. Specifically, the catching projection 53 of the spacer 50 may have a slope in such a manner that a degree of projection of the catching projection 53 increases toward the end of the wiper blade 1 from the center of the wiper blade 1. The catching recess 45 may be formed corresponding to the catching projection 53 in such a manner as to receive the catching projection 53. Since the two levers are made of a resin material, they are slightly elastically transformed when coupled to each other. When coupled, the catching projection 53 is supported by the wall of the catching recess 45, so that the two levers are prevented from being separated. Also, when the spacer 50 slides in a direction of the main lever 40, the catching projection 47 is caught by the catching recess 54. Since the main lever 40 and the spacer 50 are all made of an elastic resin material, the spacer 50 can be coupled to the main lever 40 in an interference fit manner by giving a force to the spacer 50 in the direction of the main lever 40. When the catching projection 47 is caught by the catching recess 54, the spacer 50 and the main lever 40 can be prevented from being separated.

In other words, the spacer 50 and the main lever 40 can be prevented from being separated in a double manner by the coupling of the catching projection 53 and the catching recess 45 and the coupling of the catching recess 54 and the catching projection 47.

FIGS. 15a and 15b are bottom views showing a process in which the main lever, the auxiliary lever and the spacer are coupled to each other in case of the six-point support structure. As shown in FIGS. 15a and 15b, the catching projection 53 of the spacer 50 is caught by the catching recess 45 of the main lever 40. Through this, the two levers are prevented from being separated. As a result, the wiper blade 1 according to the embodiment of the present invention includes the one main lever 40, a pair of the auxiliary levers 30, and a pair of the yoke levers 20. The main lever 40 may be coupled to various wiper arms and includes the concave portion for preventing the interference caused when the wiper arm is pivoted.

Additionally, each lever is made of a resin material. The levers which may be commonly made of a metallic material are manufactured with a resin material, so that the total weight of the wiper blade 1 can be reduced. When the levers are made of a resin material instead of a metallic material, the wiper blade can be integrally molded, so that the number of parts can be reduced. Accordingly, the process becomes simpler and manufacturing cost is reduced. Also, since the levers are made of a resin material, the flexibility of the external appearance of the wiper blade 1 may be increased.

According, to the embodiment of the present invention, when the levers are coupled, the protruding fitting portions 36 and 46 are inserted and fixed to the receiving holes 23 and 37, so that the gap between the levers is prevented from being created and a resistance to a bending moment and a torsional moment which are applied to the lever is increased when the wiping is performed.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A wiper blade comprising:
a wiper strip which wipes a wiping surface;
at least one pair of yoke levers which supports the wiper strip;
a pair of auxiliary lever which is relatively rotatably coupled to the at least one pair of the yoke levers respectively; and
a main lever which is relatively rotatably coupled to a pair of the auxiliary levers and is connected to a wiper arm,
wherein, for the purpose of preventing interference caused at the tune of pivoting with a U-hook type wiper arm “Ha,” the main lever comprises a first concave portion which is formed toward the wiper strip in a portion of the top surface of the main lever.

2. The wiper blade of claim 1, wherein the U-hook type wiper arm “Ha” comprises an arm bar connected directly to the wiper blade, wherein a bent portion is formed in the arm bar, wherein the first concave portion receives the bent portion, wherein after the bent portion extends from the center of the wiper blade in a longitudinal direction of the wiper blade by a predetermined length “X,” the bent portion extends with an oblique bend at a predetermined angle in a direction in which traveling wind blows, and then is bent again parallel with the wiper blade in an “S” shape.

3. The wiper blade of claim 1, wherein the first concave portion is formed separately from the center of the wiper blade by a predetermined length in a longitudinal direction of the wiper blade.

4. The wiper blade of claim 1, wherein the first concave portion is formed obliquely toward the lower portion from the upper portion of the main lever and toward the end from the center of the wiper blade.

5. The wiper blade of claim 1, further comprising an adaptor which is assembled on the main lever and is directly connected to the wiper arm,
wherein a side of the main lever further comprises one or more pin-holes and allowing the main lever to be coupled to a side pin-hole type wiper arm “Pa,” wherein, for the purpose of preventing interference caused at the time of pivoting with the side pin-hole type wiper arm “Pa,” the main lever further comprises a second concave portion formed concave toward the lower portion of the wiper blade, and
wherein the adaptor comprises one or more coupling recesses which contact with the one or more pin-holes respectively and receive a side-pin of the side pin-hole type wiper arm “Pa,” and comprises a U-Hook coupler having a curved portion receiving a U-Hook type wiper arm “Ha.”

6. The wiper blade of claim 1, wherein the main lever is made of a resin material.

7. The wiper blade of claim 6, wherein the at least one pair of the yoke levers and a pair of the auxiliary levers are made of a resin material.

8. The wiper blade of claim 7, further comprising a spacer which is inserted between the auxiliary lever and the main lever and is made of a resin material.

9. The wiper blade of claim 8, wherein the inside of the main lever comprises a slot intended to be coupled to the spacer and comprises a catching recess preventing the spacer from being separated from the main lever, and wherein the spacer comprises a rib intended to be coupled to the slot in a sliding manner and comprises a catching projection which is caught by the catching recess.

10. The wiper blade of claim 9, wherein the catching projection is formed to have a degree of projection thereof increasing toward the end of the wiper blade from the center of the wiper blade.

11. The wiper blade of claim 9, wherein the main lever further comprises a catching projection which projects downward from an inner ceiling of the main lever, and wherein the spacer further comprises a catching recess which is formed in the upper portion of the spacer and by which the catching projection is caught.

12. The wiper blade of claim 7, wherein the main lever comprises a protruding fitting portion which protrudes downward from an inner ceiling of the main lever, and wherein the auxiliary lever comprises a receiving hole which is formed in the upper portion thereof and receives the protruding fitting portion.

13. The wiper blade of claim 7 wherein the auxiliary lever comprises a protruding fitting portion which protrudes downward from an inner ceiling of the auxiliary lever, and wherein the yoke lever comprises a receiving hole which is formed in the upper portion thereof and receives the protruding fitting portion.

14. The wiper blade of claim 7, wherein the auxiliary lever comprises a side projection which projects from both sides of one end of the central portion of the wiper blade.

15. The wiper blade of claim 7, wherein the auxiliary lever comprises an inner projection which projects toward the inside of the spoiler from a lower inner side of the spoiler.
